(19) United States
(12) Patent Application Publication
(10) Pub. No.: US 2018/0010994 A1
(43) Pub. Date: Jan. 11, 2018

(54) Continuous in-line hydrocarbon quality analyzer

(71) Applicant: Robert L. Macomber, Maple, WI (US)

(72) Inventor: Robert L. Macomber, Maple, WI (US)

(21) Appl. No.: 15/206,557

(22) Filed: Jul. 11, 2016

(51) Int. Cl. G01N 9/36; G01N 11/00

(52) U.S. Cl. CPC G01N 9/36; G01N 11/00

(57) ABSTRACT

A device for continuous measurement of average molecular weight and polarity of a hydrocarbon stream.

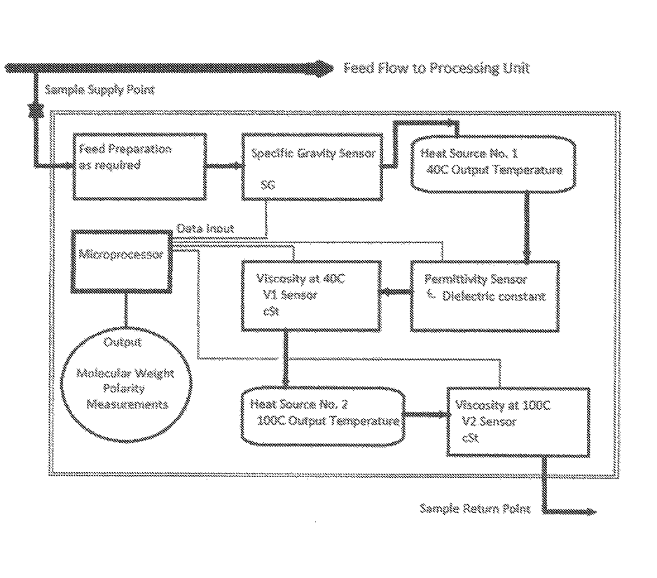

Information from the apparatus will be used to characterize the quality of charge stocks and hydrocarbon components of process or utility units. This instrument is based on the concept that each hydrocarbon molecule has a distinct viscosity at a given temperature. While some different weight molecules may have nearly the same viscosity at one temperature, the rate of change of the viscosity is different for each molecule as temperature changes. By observing the viscosity of a hydrocarbon mixture in a closed loop sampling system at two different temperatures, along with specific gravity of the mixture, the average molecular weight of the mixture can be determined. Likewise, different molecular structure (ringed aromatic hydrocarbon molecules versus straight chain hydrocarbon molecules) will have a unique polarity due to differences in electron density for the different structures. The presence of contaminants such as sulfur and nitrogen atoms in hydrocarbon molecules also causes an increase in polarity of the sample. By continuous analysis of the permittivity of hydrocarbon mixtures the relative polarity of the molecules in the hydrocarbon mixture can be observed. Together this will determine the relative Molecular weight, structure and contaminant level of the feedstock. Data can be used for immediate interpretation of the feed quality allowing immediate evaluation, adjustment and control of process units.

### BACKGROUND

Petroleum refinery process and utility units are very sensitive to changing characteristics of feed stocks. These changes can lead to process upsets which may damage the unit and cause products to fail specifications. Changes in feed characteristics may also require an immediate change in other process variables in order to maintain optimum control of unit performance. Failure to respond to changes in feed characteristics may lead to accelerated decline in catalyst activity and mechanical integrity of equipment.

### SUMMARY OF INVENTION

There is a relationship between the molecular weight of hydrocarbons to their gravity and viscosity. Once the gravity of a hydrocarbon is known, the molecular weight can be calculate using kinematic viscosities of the hydrocarbon measured at 40° C. and 100° C. Determination of instantaneous average molecular weight can be achieved by recording gravity and viscosity sensor output for immediate determination. This apparatus prepares a continuous sample of the feedstock and routes the flow such that viscosity measurements can be made at 40° C. and 100° C. Other measurements will provide specific gravity and permittivity. Signals are sent to a microprocessor where the calculations are made. The output value will represent the immediate average molecular weight of the feedstock. Molecular weight alone does not fully describe feed characteristics since a paraffin molecule may have the same molecular weight as a cyclic (aromatic) molecule but have very different feed characteristics. Aromatic molecules exhibit polarity while paraffin is predominately non-polar. Measuring the permittivity of a hydrocarbon will provide an indication of the polarity of the feed and can be used to measure the average concentration of cyclic molecules in the feed. Together, molecular weight and aromatic content can be used to characterize the quality of the hydrocarbon.

### BRIEF DESCRIPTION OF THE IMAGE

The illustration above describes a continuous sample, that is taken from the feed system of a process unit. Each application may vary in temperature, pressure and quality such that some amount of feed preparation may be required. Depending on each sample and sample location, it may be necessary to pump, filter, heat, cool or otherwise properly prepare the sample for analysis. The sample is usually divided into sections unless multiple analyses can be done with a single sensor (such, as viscosity and gravity). One of the sections allows the sample viscosity to be measured by a sensor at 40° C. Next, the sample is heated to 100° C. before it enters the second viscosity sensor. Gravity and permittivity may be measured at the same or other temperatures and corrected to a standard value. The output from each sensor is delivered by electronic signal to a micro-processor which calculates the average molecular weight and polarity from the input data. An immediate value is available and sent to the operator.

We claim

1. An electronic system for continuous characterization of hydrocarbon average molecular weight and polarity (aromatic content) based on viscosity measured at two temperatures (40° C. and 100° C. ) and permittivity.

2. The system of claim 1, wherein average molecular weight is determined by a single continuous viscosity and continuous gravity measurements.

3. The system of claim 1, wherein average molecular weight is determined by multiple continuous viscosity and multiple continuous gravity measurements.

4. The system of claim 1, wherein average molecular weight determined by measurements at multiple temperatures.

5. The system of claim 1, wherein average molecular weight and aromatic content is used to determined characteristic of process unit feed stocks, intermediates and products.

6. The system of claim 1, wherein average molecular and aromatic content may also be used to determine carbon to hydrogen ratio of hydrocarbons streams.

7. The system of claim 1, wherein average molecular and aromatic content may also be used to determine average boiling points of hydrocarbon and Watson K value.

8. The system of claim 1, wherein average molecular and aromatic content may also be used to predict reactivity and hydrogen consumption of the process feed.

9. The system of claim 1, wherein average molecular and aromatic content may also be used to calculate required heat input of the process unit.

10. The system of claim 1, wherein average molecular and aromatic content may also be used to calculate catalyst deactivation rate.

11. The system of claim 1, wherein average molecular and aromatic content may also be used to calculate target charge rates.
